(19) United States
(12) Patent Application Publication
(10) Pub. No.: US 2019/0019147 A1
(43) Pub. Date: Jan. 17, 2019

(54) SYSTEM AND METHOD FOR DEVICE CLEARING AND RE-INVENTORY

(71) Applicant: FedEx Supply Chain Logistics & Electronics, Inc., Fort Worth, TX (US)

(72) Inventors: Joel MCCARTY, Edmond, OK (US); Edgar GRIGALIS, Fort Worth, TX (US); Tammy LLOYD, Lewisville, TX (US)

(21) Appl. No.: 15/649,541

(22) Filed: Jul. 13, 2017

(51) Int. Cl. G06Q 10/08; G06Q 10/00; G06F 11/22

(52) U.S. Cl. CPC G06Q 10/0837; G06Q 10/087; G06F 11/22; G06Q 10/30; G06Q 10/20

(57) ABSTRACT

The disclosed embodiments include a method to automatically re-inventory an electronic device. The method includes collecting electronic device information upon receipt of the electronic device at an electronic device returns facility. The method also includes performing re-inventory testing of the electronic device, and the method includes performing reconditioning operations on the electronic device in response to results of the re-inventory testing. Additionally, the method includes automatically re-inventorying the electronic device upon completion of the reconditioning operations.

### BACKGROUND

The present disclosure relates generally to systems and methods to test and re-inventory a returned electronic device.

The use of and development of communications has grown nearly exponentially in recent years. The growth is fueled by larger networks, more reliable protocols, enhanced software functionality, and better communications hardware available to service providers and consumers. As a result, more people than ever are buying and using electronic devices. Correspondingly, the number of returns, repairs, refurbishments, and re-inventories of electronic devices are at record levels creating logistical problems.

Under various circumstances, users may return electronic devices to an original equipment manufacturer (OEM), retailer, repair facility, service provider, or other entity. Electronic devices are often returned for repairs, refurbishment, exchanges, warranty issues, or any number of other justified or arbitrary reasons. Many of these electronic devices remain in a usable condition or a condition that is redistributable to a marketplace with minimal refurbishment. However, during the returns process, the electronic devices may be mismanaged due to inefficiencies of the return and repair or refurbishment process.

### SUMMARY

The disclosed embodiments provide systems and methods to automatically re-inventory an electronic device. One embodiment includes a method to automatically re-inventory an electronic device. The method includes collecting electronic device information upon receipt of the electronic device at an electronic device returns facility. The method also includes performing re-inventory testing of the electronic device, and the method includes performing repairs or refurbishment operations on the electronic device in response to results of the re-inventory testing. Additionally, the method includes automatically re-inventorying the electronic device upon completion of the repairs or the refurbishment operations.

Another embodiment includes a computer implemented method for automatically re-inventorying an electronic device. The method includes collecting electronic device information upon receipt of the electronic device at an electronic device returns facility. Additionally, the method includes performing CPI testing of the electronic device, and removing CPI from the electronic device in response to detecting the CPI on the electronic device during the CPI testing. Further, the method includes verifying removal of the CPI from the electronic device, and automatically re-inventorying the electronic device upon verification that the CPI has been removed from the electronic device.

Yet another embodiment is a warehouse management system. The warehouse management system includes a processor for executing a set of instructions and a memory for storing the set of instructions. The set of instructions are executed by the processor to collect electronic device information upon receipt of an electronic device at an electronic device returns facility. The set of instructions are also executed to perform re-inventory testing of the electronic device, and to determine at least one repair or refurbishment operation to be performed on the electronic device in response to results of the re-inventory testing. Further, the instructions are executed to automatically re-inventory the electronic device upon completion of the repairs or the refurbishment operations.

Additional details of the disclosed embodiments are provided below in the detailed description and corresponding drawings.

### BRIEF DESCRIPTION OF THE DRAWINGS

Illustrative embodiments of the present invention are described in detail below with reference to the attached drawing Figures, which are incorporated by reference herein, and wherein:

FIG. 1 is a pictorial representation of a merchandising process in accordance with an illustrative embodiment;

FIG. 2 is a flow diagram of a process flow for processing electronic devices to remove customer private information in accordance with an illustrative embodiment;

FIG. 3 is a block diagram of a system for merging customer private information in accordance with an illustrative embodiment;

FIG. 4 is a flowchart of a process for determining the presence of customer private information on an electronic device in accordance with an illustrative embodiment;

FIG. 5 is a flowchart of a process for verifying removal of customer private information from an electronic device in accordance with an illustrative embodiment;

FIG. 6 is a flowchart of a process for auditing electronic devices for CPI during processing in accordance with an illustrative embodiment;

FIG. 7 is a pictorial representation of a graphical user interface for removing customer private information from an electronic device in accordance with an illustrative embodiment;

FIG. 8 is a flowchart of a process for processing a device for CPI in accordance with an illustrative embodiment;

FIG. 9 is a flowchart of a process for allocating units in accordance with an illustrative embodiment; and

FIG. 10 is a flowchart of a process for shipping a unit in accordance with an illustrative embodiment.

FIG. 11 is a flowchart of a process for resolving a return merchandise authorization (RMA) request prior to issuance of an RMA in accordance with an illustrative embodiment;

FIG. 12 is a flowchart of a process for re-inventorying an electronic device that is returned under an RMA in accordance with an illustrative embodiment;

FIG. 13 is a tree diagram illustrating a process for processing product return requests in accordance with an illustrative embodiment; and

FIG. 14 is a flowchart of a process for automatically re-inventorying an electronic device in accordance with an illustrative embodiment.

The illustrated figures are only exemplary and are not intended to assert or imply any limitation with regard to the environment, architecture, design, or process in which different embodiments may be implemented.

### DETAILED DESCRIPTION

The illustrative embodiments provide a system and method for refurbishing and automatically re-inventorying electronic devices. In logistical, returns, and warehousing facilities and systems, one or more checks, determinations, scans, or searches for electronic device malfunctions or customer private information (CPI) presence may be performed before or after standardized processes occur for the returned electronic device (e.g., repair, refurbishment, and re-inventory of the electronic device). The checks enable a management system to automatically perform the standardized processes on the electronic device.

Electronic devices may include computing and telecommunications devices including cell phones, PDAs, smartphones, laptops, e-readers, mp3 players, and other forms of personal, business, or consumer electronic devices. CPI may include information, such as names, phone numbers, addresses, e-mail addresses, IP addresses, social security numbers, databases, email addresses, bank accounts, contact lists, address books, passwords, usernames, and other sensitive information associated with the user or utilized by the user.

The embodiments as herein described, may be automated or may require user interaction. In particular, the illustrative embodiments provide a system and method for automatically re-inventorying returned electronic devices upon completion of repairs or refurbishment operations. The illustrative embodiments may be utilized to check for defects of the returned electronic devices. All electronic devices with defects may be identified with relevant information or metadata stored for local or distributed utilization by one or more parties. Additionally, the embodiments provide mechanisms for repairing the defects of the electronic devices to make the devices suitable for re-inventory and redistribution to the marketplace. Upon completion of the defect repair, the returned electronic devices are automatically re-inventoried for subsequent distribution.

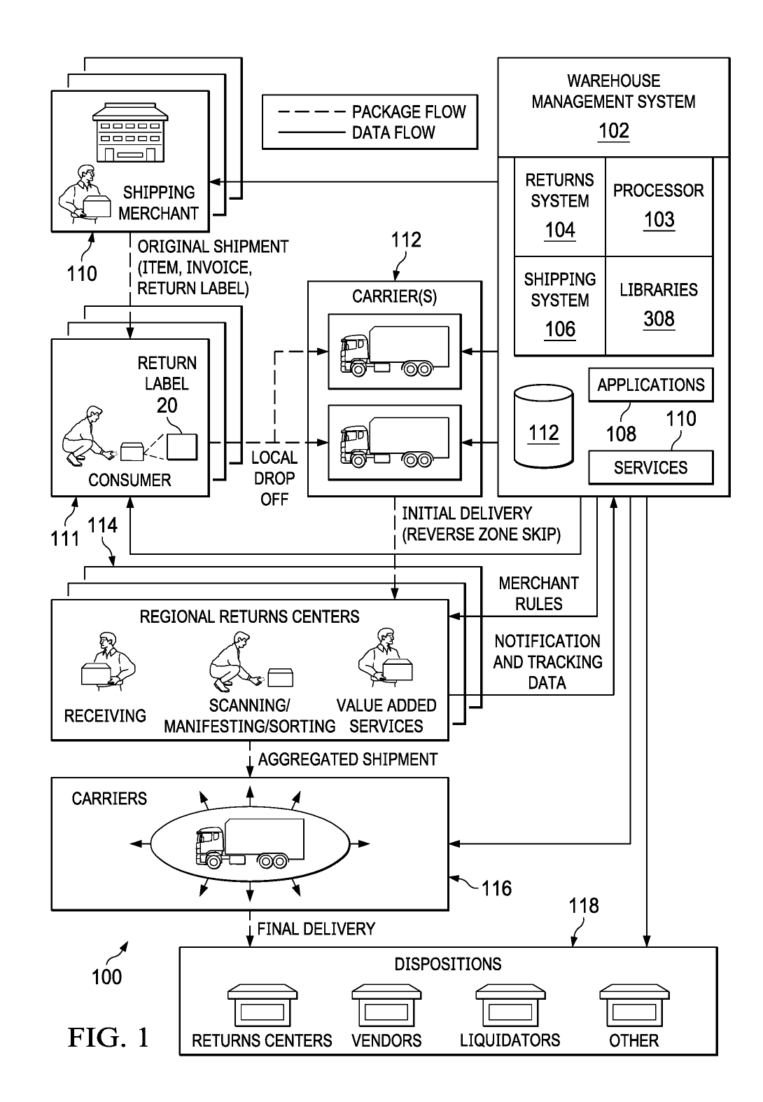

FIG. 1 is a pictorial representation of a merchandising process in accordance with an illustrative embodiment. In one embodiment, the merchandising process 100 of FIG. 1 may be implemented by a warehouse management system (WMS) 102. The WMS 102 may include at least one processor 103, a returns system 104, a shipping system, applications 108, services 110, libraries 308, and databases 112. The merchandising process 100 and WMS 102 may be utilized to receive, process, and ship electronic devices. Additionally, the WMS 102 may audit the detection and removal of defects of the electronics device during any part of the merchandising process 100. Further, the WMS 102 may re-inventory returned electronic devices for subsequent redistribution to the marketplace.

During all or any step or portion of the merchandising process 100, electronic devices may be analyzed to determine whether CPI is present and, if present, to remove the CPI so that the electronic device may be further processed. In one embodiment, electronic devices may be randomly tested during the merchandising process 100 to determine whether CPI is present. The WMS 102 is one embodiment of an information and data processing system that tracks and records the processing of the electronic devices through one or more facilities. FIG. 1 illustrates both the flow of packages, inventory, and electronic devices as well as data flow (as described by the included legend).

The WMS 102 is used to collect data scanned from return labels, and to process the returns. The processing center 102 includes the computer processing equipment 103, including computers, data storage, scanners (i.e., barcode, RFID, etc.) and networking equipment, appropriate for communication of data to and from returns centers, merchants, and customer, as appropriate.

The computing equipment 103 is programmed to fulfill the various data processing and CPI removal services described herein. In one embodiment, the WMS 102 includes nodes, computers, access points, terminals, or other elements for displaying information, receiving user input, and scanning the electronic devices as moved through each stage of the merchandising process 100. For example, WMS 102 may provide a web page or other network-accessible data source, accessible by customers for obtaining information about returns and data for printing return labels. The WMS 102 also stores business rules from merchants, which may be delivered to it by electronic transmission over a data communications network. As explained below, the WMS 102 matches data on the return label to the merchant rules, which may specify disposition of the package or other rules for handling and/or to an identifier associated with an electronic device, the return.

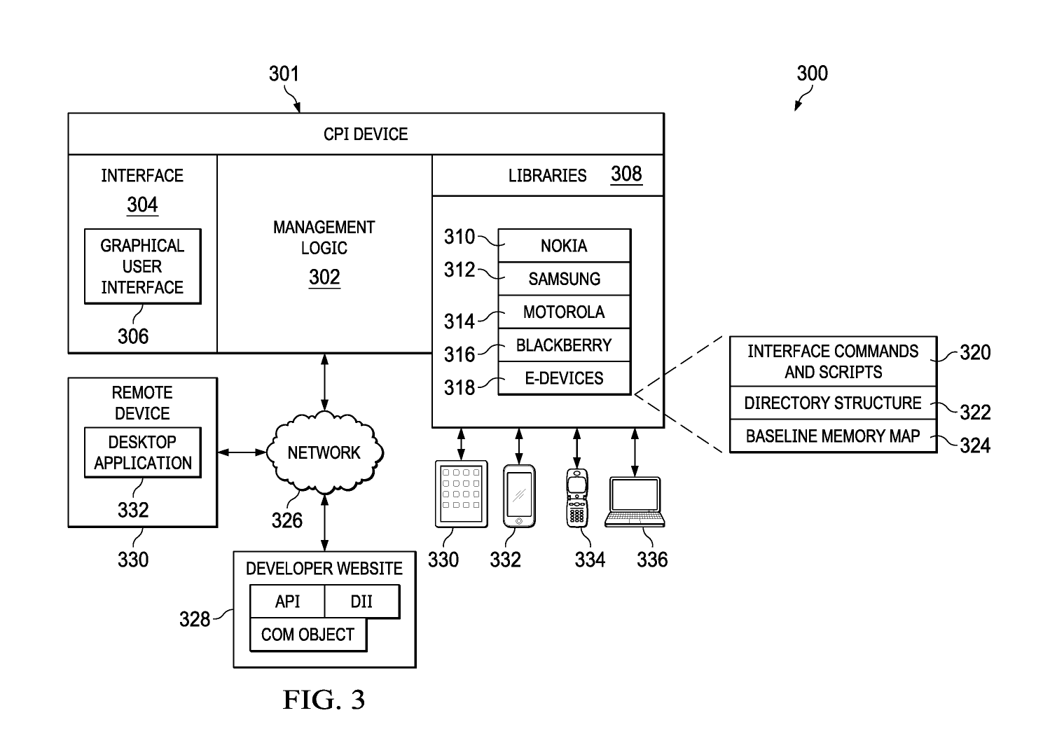

The WMS 102 may include a CPI device operable to determine whether CPI is present on one or more electronic devices as described in FIG. 3. The returns system 104 and shipping system 106 may be modules, instructions, or hardware elements dedicated to tracking returns and shipping of electronic devices, respectively. The applications 108 may represent any number of standard or customized applications that may be part of the WMS 102. The services 110 may represent other features and services that may be provided during the merchandising process 100 and/or by the WMS 102.

The database 112 may store information about electronic devices and other inventory that is tracked as it moves through the merchandising process 100. In particular, the database 112 may track information relating to the detection and removal or attempted removal of CPI from electronic devices. For example, the WMS 102 may record when CPI was first detected, the operator and system detecting the CPI, the quarantine process including marking the device physically and electronically as quarantined, and the process for removing or attempting to remove the CPI in finite detail. In one embodiment, the returns system 104 or the shipping system 106 may generate a quarantine label indicating that the device is at least temporarily quarantined. For example, the label may include a barcode or other scannable identifier.

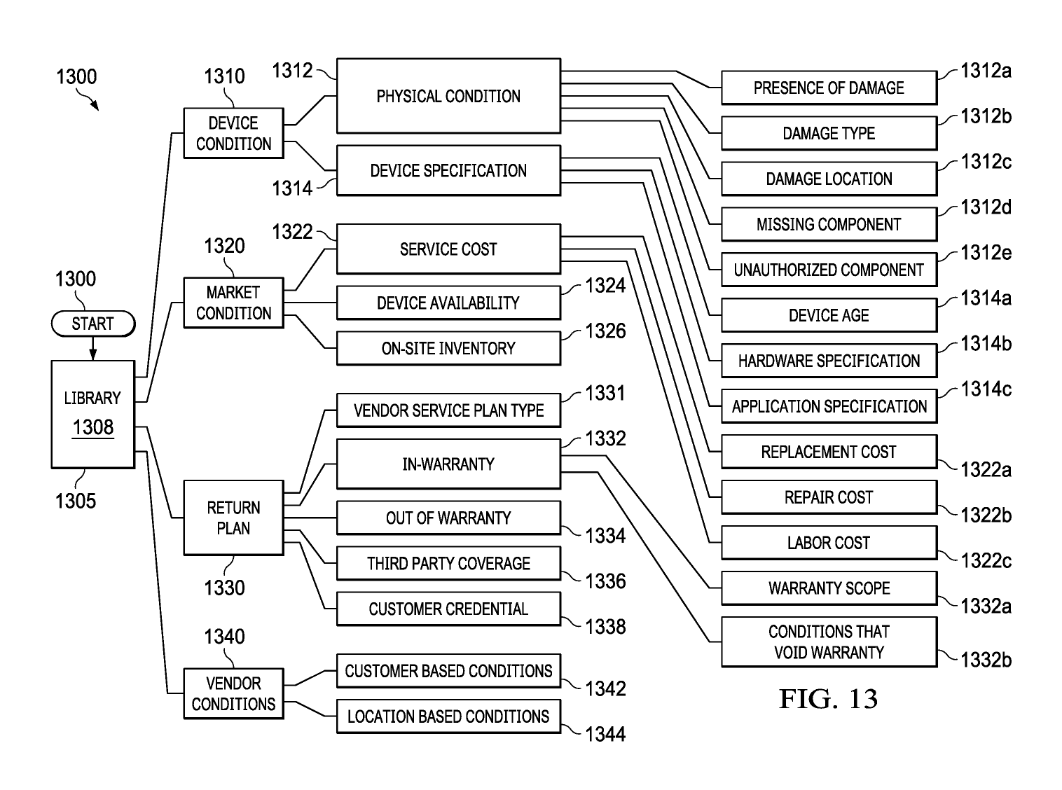

The library 308 is non-volatile memory. Examples of the library 308 may include any type of data storage component such as a hard drive, a flash drive, or memory card. The library 308 is operable to store persistent data such as, but not limited to, computer executable instructions associated with software applications or an operating system. The processor 103 is operable to access the library 308 to obtain one or more machine instructions and to execute the machine instructions to perform one or more of the operations described herein. In particular, the library 308 includes the instructions used to perform the process 1300, which is described in detail below with respect to FIG. 13.

The applications 108, services 110, and database 112 may communicate with one or more internal or external networks to communicate status, tracking, and other information regarding the processing of electronic devices. For example, the services 110 may send automated messages to a service provider based on the database 112 indicating that CPI has been found on incoming device(s) that relates to the service providers processes and business. In addition, the service provider, retailer, or other third party may receive notices according to rules utilized by the WMS 102 when electronic devices are received, value added services are performed (i.e. repair, refurbishment, etc.), and when the shipping label is generated to fulfill an order. The rules between the returns provider and service provider govern communications, notifications, and remote access to the WMS 102.

In one embodiment, returns are processed through a returns provider that manages and logistically handles returns for multiple merchants. The systems and methods herein described may also be easily adapted for a returns provider that handles only returns for a single merchant. In either case, the merchant is considered to maintain at least one returns center, whether by directly maintaining the returns center(s) or by associating with a third party that does so.

In step 110, a merchant, service provider, or other party has delivered an item to a customer. In step 111, the customer has decided to return the item, herein referred to as “the return item.” A returns label 20 may have already been, or is to be, provided to the customer. For example, the return label 20 is delivered as an enclosure with the customer's original order, such as by being part of the customer invoice or a separate insert.

In other embodiments, the return label 20 could be downloaded from a data network and printed by the customer, or otherwise delivered to the customer by means other than being included with the merchandise delivery. For example, the return label may be separately mailed or sent by facsimile. As another example, the customer might access a website provided by the merchant, link to a returns page, and download the data for printing the return label.

The return label 20 is “pre-authorized” in the sense that the customer not need seek authorization from the merchant. The customer is apprised by the merchant that returns are pre-authorized, such as by information on the invoice or other shipping documents. The notification may be explicit on the return label or elsewhere or may be implicit. The customer may be further apprised that the customer need not pay shipping charges, such as by a “no postage necessary” printing on the return label 20.

The customer may affix the returns label 20 to the packaging for the return item and deliver over the return item to a carrier without paying any shipping charges to the carrier. The customer not need to affix any address markings, make payments, or present indicia of postage, or go through any other shipping process as the return label may accurately represent the necessary information. The returns label may further indicate that delivery charges are to be paid by a recipient. The returns label 20 further identifies the transaction leading to the return. In one embodiment, this is a purchase transaction and the identification is by invoice number or other indicia of the package or its contents. In other embodiments, the transaction could be a warranty claim, repair request, or bulk shipment from a service provider, retailer, or other party.

In step 112, the carrier delivers the return item to the returns provider. As stated above, in the embodiment of FIG. 1, the initial point of return for the package is a standard or specialized returns center, which may receive returns for more than one merchant. The returns center may be regional for a large area such as the United States. In other words, a large geographic area may have a number of returns centers. At the time the data for each returns label 20 is composed, the destination address on the label 20 is determined based on the available returns centers.

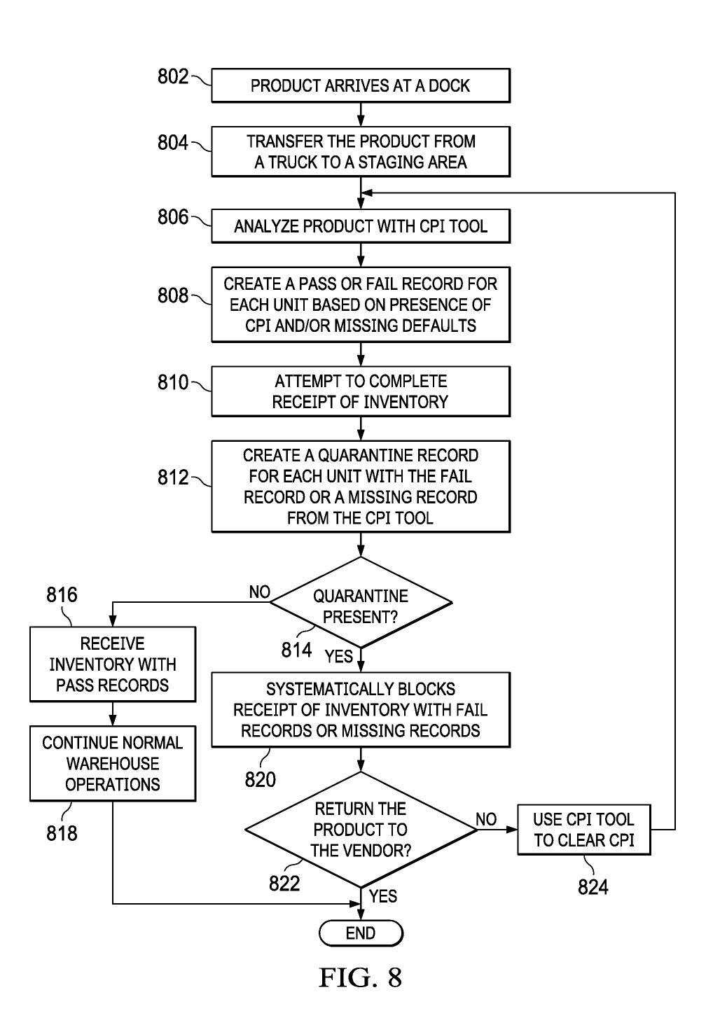

In step 114, the returns provider receives the package from the carrier. The returns provider may scan the return label on the package and weigh the package. Any special shipping flags or indicia are entered at this time. For example, the indicia may indicate that an included electronic device may have CPI. In one embodiment, the process of FIG. 8 may be implemented when electronic devices are received.

The electronic devices may be scanned for CPI and if present may be physically and/or electronically quarantined. For example, the electronic device or associated package may be marked with a quarantine label and an electronic quarantine information associated with an identifier of the electronic device and/or associated package. Although, not show, the electronic devices may be sent to a quarantine area for removal of the CPI utilizing a CPI device. In one embodiment, individual electronic devices or batches of devices may be rejected or prevented from being received individually or collectively. In particular, the WMS 102 and return system 104 may prevent the device from being entered in the system while CPI is present. In this manner, the returns provider receives multiple packages, which may be items originating from multiple merchants or customers, throughout a daily course of business.

In a process known as manifesting, the returns provider calculates the shipping charges due to the carrier and electronically manifests the carrier. In one embodiment, this is done on a daily basis. In the example of this description, the returns provider pays the carrier, and is compensated by the merchant for carrier costs and other services.

The returns provider may then sort the packages by merchant, again using data printed on return label 20 or another indicia affixed by the returns provides, and collects the packages associated with each merchant. The final destination code is encoded on the return label, and may also be printed in human readable form. For large volume merchants, the destination code may be associated with a package chute and/or a docking door.

The returns provider may also provide “value added” services for the benefit of the merchant, such as notification of the return to merchant or notification to the customer of receipt of the package. For example, the returns provider may use the scanned return label information to notify the customer and/or the merchant that the package has been received and whether or not the electronic device was received with CPI. This information may be particularly useful to a service provider that has previously paid a third party or has itself processed a device to remove CPI. In one embodiment, the WMS 102 may document the location and type of the CPI as well as uploading a memory map that proves CPI was present for additional analysis or comparison as needed.

Value added services may include repairing, refurbishing, updating, recycling, or otherwise processing the electronic devices and the associated steps, such that they are suitable for further disposition including return, resale, standard usage, and so forth. After the value added services have been performed, the electronic devices may be systematically or randomly analyzed for CPI.

In step 116, after aggregating the packages for each merchant, the returns provider further ships them in accordance with whatever policies are specified for that merchant. For example, the returns provider may palletize shipments back to the merchant. The return label data is used to create a bill of lading, with data such as pallet counts, package counts, and shipment weight. In addition, electronic devices may be shipped back individually to other returns centers, vendors, liquidators, customers, stores, or other parties. In one embodiment, the policies are implemented electronically by the WMS 102.

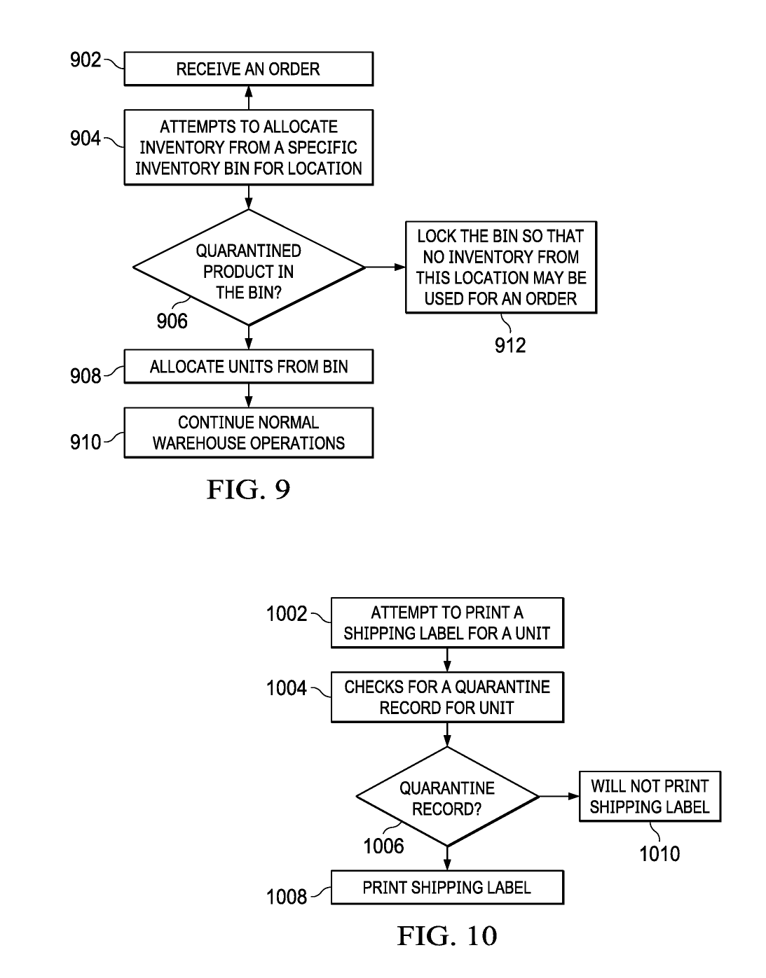

Before an order may be fulfilled or the return label may be printed, a final CPI verification may be required as further illustrated in FIGS. 8 and 9. In step 118, the package is handled according to the disposition policy or rules of the merchant, such as by being returned to stock, sent to a re-seller, liquidator, or otherwise disposed.

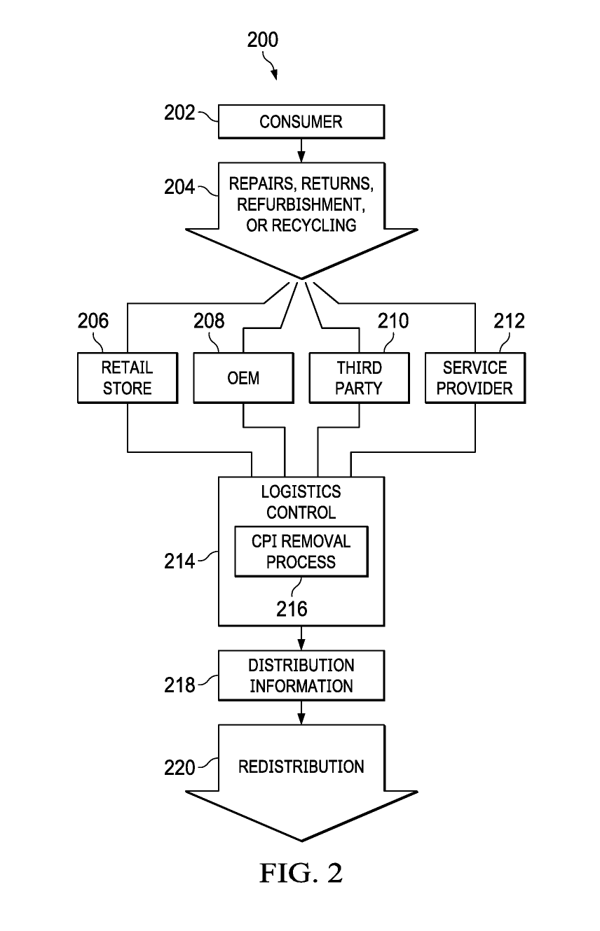

FIG. 2 is a flow diagram of a process flow 200 for processing electronic devices to remove customer private information in accordance with an illustrative embodiment. The process flow 200 illustrates one embodiment of electronic devices being managed and processed for subsequent redistribution. The process flow 200 may include any number of users, participants, steps, and systems that may be automated or implemented based on user input.

In one embodiment, a consumer 202 returns one or more electronic devices. The consumer 202 may physically present the electronic device, ship the device or connect the device to a portal or an interface managed by a service provider. In one embodiment, the electronic device is presented or supplied for repairs, returns, order fulfillment, refurbishment, or recycling 204. In addition, the electronic device may be received for any number of other purposes not specifically described such as upgrades, reconfiguration or user transfer.

The parties that may communicate or interact with the consumer 202 to receive the electronic device or devices for repairs, returns, order fulfillment, refurbishment, or recycling 204 may include a retail store 206, an OEM 208, a third party 210 and a service provider 212 (collectively, the “parties” 213). The retail store 206, OEM 208, third party 210 and service provider 212 represent a few of many possible parties, organizations, groups or individuals that may receive the electronic devices. The parties 213 may physically or electronically present electronic devices to a logistics control 214.

In one embodiment, the logistics control 214 is a warehouse management facility or operation that is operable to process electronic devices for repairs, returns, refurbishment or recycling 204. The logistics control 214 may have legal or contractual obligations or agreements with the parties 213 to process the electronic devices. The logistics control 214 may also be utilized when the parties 213 need to process an electronic device in a way which is incompatible with their business model, technical skills, or day-to-day operations.

The logistics control 214 may include any number of systems, equipment, and devices configured to detect and remove CPI. In one embodiment, the logistics control 214 may implement a CPI removal process 216 in order to clear the CPI from electronic devices for subsequent reuse and/or redistribution. For example, a number of users may connect electronic devices to a test stand to detect and remove CPI for a service provider. The CPI removal process 216 implemented by the logistics control 214 is further described in terms of systems, devices, interfaces, and methods described herein, such as in FIGS. 3-6.

The CPI removal process 216 may track and record all information relevant to the removal of CPI information from the electronic devices for subsequent access or reporting performed by the logistics control 214 or the parties 213. In one embodiment, the CPI removal process 216 includes a portal and database storing the CPI-related information for retrieval by the logistics control 214 and the parties 213. The logistics control 214 may include any number of different facilities or systems that may operate independently or may be networked. As a result, the CPI removal process 216 may communicate with any number of other logistical control centers and CPI removal systems and processes to perform tracking, reporting, auditing, and verification.

If or once electronic devices are satisfactorily cleared of all CPI, distribution information may be utilized as part of redistribution 220. Redistribution 220 may include returning the individual electronic devices to the respective parties 213 or the consumer 202, sending the electronic devices according to the distribution information 218, or otherwise shipping or processing the electronic devices.

In one embodiment, in which the CPI removal process 216 is performed remotely from the facility or systems of the consumer 202 or the parties 213, redistribution 220 may entail returning control to the applicable parties or activating or authorizing the electronic devices to function normally. For example, once the logistics control 214 begins implementing management of the electronic devices, all other functionality may be locked out for the electronic devices (with the exception of failsafe or failover operations).

FIG. 3 is a block diagram of a system 300 for merging customer private information in accordance with an illustrative embodiment. The system 300 is one embodiment of a device, networked computing system, or environment in which CPI may be detected, removed and reported.

In one embodiment, the system 300 may include a CPI device 301 or system. The CPI device 302 may be utilized to detect and remove CPI information. In one embodiment, the CPI device 301 may include management logic 302, an interface 304, a graphical user interface 306, libraries and models 308 including libraries for Nokia 310, Samsung 312, Motorola 314, Blackberry 316, E-devices 318, interface commands and scripts 320, a directory structure 322 and a baseline memory map 324. The CPI device 301 may further communicate with a network 326. The network 326 may communicate with a developer website 328. The system 300 may be utilized to test electronic devices 330-336.

In one embodiment, the CPI device 301 is a personal computing device, such as a desktop computer configured to communicate with one or more electronic devices 330-336 concurrently or simultaneously. In another embodiment, the CPI device 301 may be a server or other network device that acts as a master WMS and is accessible to any number of remote computing devices or terminals to perform the methods herein described. The CPI device 301 may include any number of computing or communications elements not specifically described herein including, but not limited to, motherboards, busses, ports, cards, interfaces, adapters, peripherals, displays, jacks, processors, memories, operating systems, applications, modules or similar hardware or software components. The CPI device 301 may include WMS hardware, software, equipment and interfaces in addition to the described elements.

In one embodiment, the management logic 302 is the logic that implements the CPI recording and removal. The management logic 302 may include one or more processors and memories configured to execute commands, instructions, or codes to perform the CPI management. In another embodiment, the management logic 302 may be core software executive or a software module that controls the other functions of the CPI device 301.

The processor of the management logic 302 is circuitry or logic enabled to control execution of a set of instructions. The processor may be microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory of the management logic 302 is a hardware element, device, or recording media configured to store data for subsequent retrieval or access at a later time. The memory may be static or dynamic memory. The memory may include a hard disk, random access memory, cache, removable media drive, mass storage, or configuration suitable as storage for data, instructions, and information. In one embodiment, the memory and processor may be integrated. The memory may use any type of volatile or non-volatile storage techniques and mediums.

The management logic 302 may be operable operate automatically or autonomously with or without user input in multiple instances and with multiple display outputs (i.e., screens, views, windows, etc.). In another embodiment, the management logic 302 may require user interactions to connect the electronic devices 330-336 and provide user input.

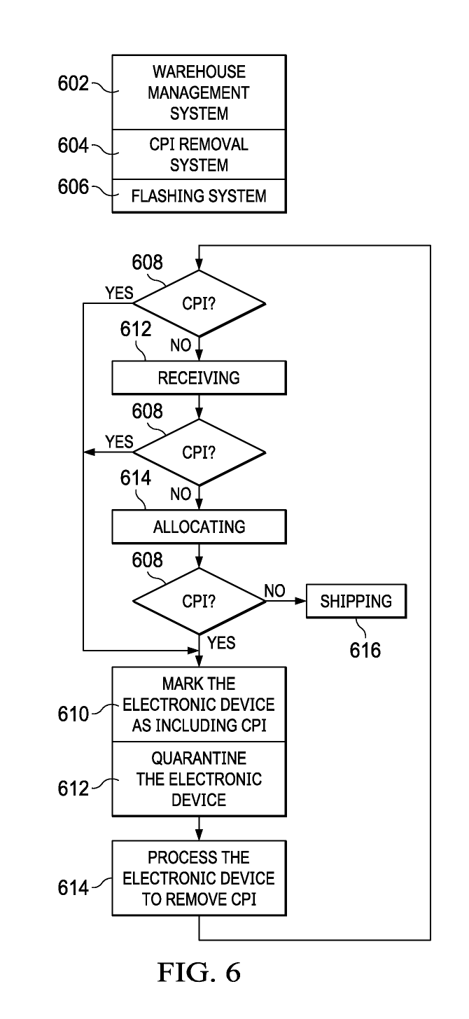

The interface 304 is an input/output system for interacting with the user audibly, visually, and/or tactilely. The interface 304 may include a keyboard, monitor, mouse, voice control system, touch pad, track ball, or other systems or devices for interacting with a user. In one embodiment, the graphical user interface 306 provides a visual interface for interacting with the user. One embodiment of the graphical user interface 306 is illustrated in FIG. 6. The graphical user interface 306 may display information regarding the connected electronic device 330-336, ongoing CPI removal, reports, updates, and other information.

The network 326 is a network operable to communicate data, packets, voice signals, and other electronic communications. The network 326 may represent any number of public or private networks. In one embodiment, the network 326 is an Ethernet network. The network 326 may be utilized to communicate with developer website 328, OEMs, service providers, and other parties to communicate CPI removal reports, problems, libraries, scripts, memory maps, and other electronic communications or resources utilized by the CPI device 301.

The libraries 308 includes the electronic information, models, data, scripts, logic, processor, and programs for detecting and removing CPI from the electronic device 330-336. The libraries 308 may include open source or proprietary information and databases. The libraries 308 may store information for any number of device, models and configurations. Examples of libraries for Nokia 310, Samsung 312, Motorola 314, Blackberry 316, and E-devices 318 are shown. In one embodiment, the libraries 308 may include information designating a baseline memory map and locations in memories of various makes and models that need to be overwritten, searched, or deleted to completely remove the CPI. The various manufacturers, service providers or others may provide scripts, programs, or modules configured to detect and/or delete CPI. Likewise, the libraries 308 may store and update firmware, operating systems, applications, and other versions that are installed on the electronic devices 330-336 before, during, or after the CPI removal process.

In one embodiment, the libraries 308 may include applications that are temporarily installed on the electronic devices 330-336 in order to detect or detect and remove CPI. For example, for electronic device 334, a Java application may be required to be temporarily installed to interface with the phone. Temporary applications may be required when there is a limited API or the applicable electronic device grants limited privileges to outside systems or devices. The temporary application may perform the detection and/or removal. Once the temporary application within the libraries 308 has ensured the CPI is removed, the temporary application may be deleted or otherwise uninstalled by the CPI device 301 or from the electronic device. The CPI device 301 may also verify that the temporary application has been removed.

In one embodiment, content within the libraries 308 may include the interface commands and scripts 320, the directory structure 322, and the baseline memory map 324. The commands and scripts 320 provides data, commands, and information, such as how to perform a query, enabling the CPI device 301 to interface with specified electronic devices. The directory structure 322 provides details regarding the likely or possible locations of CPI within specified electronic devices. The baseline memory map 324 may provide a template of what a baseline, cleaned, or default memory map of an electronic device should be (or be configured) for comparison with a real-time memory map of a tested electronic device to identify and remove CPI. The baseline memory map 324 may also identify the types of memory utilized by the electronic device, such as flash memory and a hard drive. In one embodiment, the baseline memory map 324 may also store a scan or electronic imaging of the electronic device 334 before CPI removal for comparison with another baseline memory map 324 or imaging of the electronic device performed after an attempt to remove the CPI was performed. The electronic image or other form of memory map of the electronic devices 330-336 may be stored in the CPI device 301 for access by the remote device 330 or other devices, systems or parties. For example, a retailer may access the electronic imaging performed for the electronic device 334 to ensure that CPI was properly removed when servicing the electronic device 334 or addressing a customer issue.

The CPI device 301 may include any number of ports, jacks, interfaces, hubs, or electronic interfaces (with or without built-in cords) for physically or wirelessly connecting the electronic devices 330-336 to the CPI device 301. In one embodiment, testing may be initiated automatically by the management logic 302 in response to connecting the electronic device 334 to the CPI device 301. The CPI device 301 automatically determines the manufacturer, model, variant, and software version for the electronic devices 330-336. The CPI device locates and determines CPI, such as data, pictures, contacts, menu items, called log entries, user applications, and so forth, that do not conform to a desired state for that electronic device. The desired state may be referred to as the baseline memory map 324 or baseline profile model without CPI. In one embodiment, if the CPI device 301 does not recognize the electronic device 323, the graphical user interface 306 may prompt the user to enter a model for the electronic device. If no model exists, the CPI device 301 may prompt the user to enter information or retrieve information for determining the desired state and for configuring the CPI device to test the electronic device 324 (or similar devices) for future testing. For example, the user may be prompted to enter a time/date, serial number, identifiers, and state of the device when tested.

The electronic devices 330-336 represent the devices under test. Any combination of the electronic devices 330-336 may be tested simultaneously or concurrently. For example, eight netbook models with a single configuration may be tested simultaneously by the CPI device 301. In another example, a test for electronic device 330 may be initiated and may continue to run while tests are initiated and executed for electronic devices 332 and 334 allowing each of the tests to be implemented separately and run at the same time. In one embodiment, the CPI device 301 may include multiple partitions that are accessible to store and test distinct device types and configurations that may have hardware or software conflicts.

Each of the electronic devices 330-336 may require different testing. Testing may involve comparing a desired state (such as a model with all CPI removed) with a state determined for a model of an electronic device under test and variations and baseline characteristics of that electronic device.

In another embodiment, the system 300 may include a remote device 330 locally or remotely executing a desktop application 332. The remote device 330 may be operated by one or more remote users to perform the functions and operations of the CPI device 301. In one embodiment, the CPI device 301 is a networked device that includes or manages a database including the libraries 308. The CPI device 301 may be accessible by the remote device to clear CPI off of devices that are connected to the remote device 330. The desktop application 332 may include the desktop application 332 for clearing the CPI as described for the CPI device. The desktop application 332 may be locally stored and installed, a web interface, or a network application that may be accessible through a server, advanced intelligent network device, or the CPI device 301.

In one embodiment, the remote device 330 may be provided to a communications service provider dealer network, retail stores, or other parties that may need to remove CPI. For example, the operator of the remote device 330 may have a license and operation agreement with the operator of the CPI device 301 to remotely access the CPI device 301 or to perform the features and functionality of the CPI device 301 including potentially proprietary CPI removal applications, libraries, and processes utilized by the management logic 302 and the libraries 308.

In one embodiment, the remote device 330 may access the databases and functions of the CPI device 301 utilizing a SSL connection through the network 326. Other forms of secure communication known to those skilled in the art may alternatively be utilized. The remote device 330 may access information including audit and reporting records for specified devices to determine whether CPI removal has been previously been performed or attempted. As a result, problems, variations, or exceptions may be detected, analyzed, quantified, and documented. The remote device 330 may be granted full access or access on a transaction-by-transaction basis. For example, an operator of the remote device 330 may be required to enter an IMEI that authorizes the remote device 330 to communicate with the CPI device 301. The remote device 330 may be utilized to determine whether a device is authorized and CPI free or whether the device has been compromised.

In one embodiment, the operator of the CPI device 301 may charge retailers, refurbishers, and other parties a fee to lease, acquire, or access the functionality of the CPI device 301, the desktop application 332, the libraries 308 or services available. For example, the retailer may lease the CPI device 301 or the remote device 330 as well as paying for service fees or update costs associated with updates to the desktop application 332 and/or the libraries 308.

The processes of the illustrative embodiments may be stored as a set of rules or policies that are electronically and/or manually implemented to govern processing of electronic devices. In one embodiment, the rules may be utilized by a processing system, such as a warehouse management system, to ensure that electronic devices found to contain CPI are properly quarantined until the CPI is verifiably removed. Verifiably removed indicates that a removal or flashing process has been implemented with the electronic device being tested, scanned, or analyzed afterwards to ensure that the CPI is no longer present on the electronic device. In one embodiment, the verification may be performed by comparing a memory map before and after (or with a baseline memory map) to ensure identified CPI was removed. Processing of the electronic devices may be performed utilizing bar codes or other machine readable information integrated with, attached to, or associated with each electronic device.

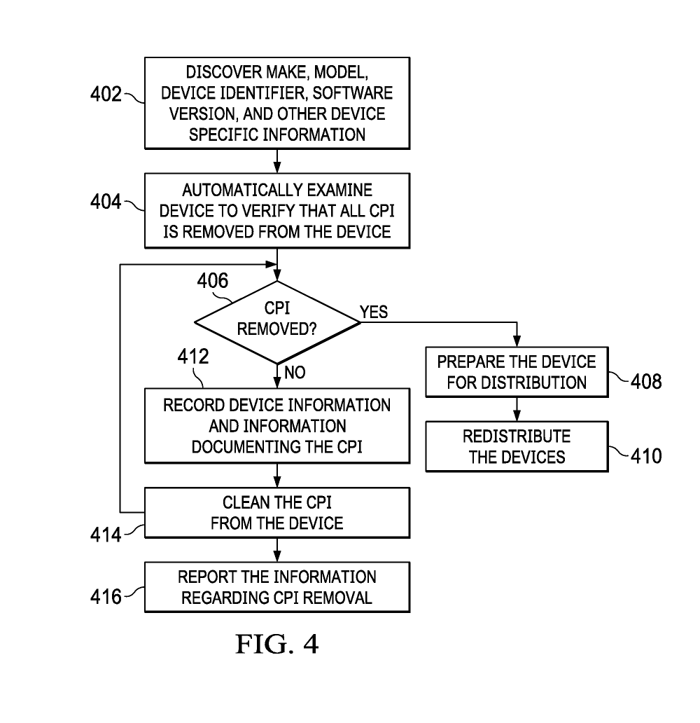

FIG. 4 is a flowchart of a process for determining the presence of customer private information on an electronic device in accordance with an illustrative embodiment. The process of FIG. 4 may be implemented by a CPI device with or without user interaction. In one embodiment before the process of FIG. 4 may be implemented one or more electronic devices are electrically connected to the CPI device. For example, a micro-USB connector may be connected to the electronic devices being analyzed, updated, reconfigured, and cleared. In another embodiment, the electronic device may be connected to the CPI device for reconfiguration through a wireless connection, which may include GSM, Bluetooth, WiFi, WiMAX, future equivalents, or other similar connections. The process of FIG. 4 is utilized to test one or more electronic devices by performing statistical monitoring, state recognition, notification or recording of determined states, recognizing the broadest possible range of devices by model and variant, and automating the assessment and actions based in the various determinations.

The process may begin by discovering a make, model, device identifier, software version, and other device specific information (step 402). During step 402, the CPI device may scan and analyze the type and configuration of the device. The device identifier may include determining a make, model, International mobile equipment identity (IMEI), IP address, software version, phone number, subscriber identity module (SIM) card, or other hardware or software that identifies the electronic device.

Next, the CPI device automatically examines the device to verify that all CPI is removed from the device (step 404). The determination of step 404 may be performed before or after other manual or automatic steps have been taken to remove CPI. The CPI device may scan or retrieve data from specific areas of memory to determine whether there is CPI on the device. In one embodiment, the CPI device may perform the determination based on information retrieved during step 402. For example, particular makes and models of devices may have specified locations for storing CPI. The CPI device may utilized particular circuits, logic, scripts, or algorithms to perform step 404 based on the information determined during step 402. During step 404, the current state of the device may be compared against a desired state for the device. The current state may include a real-time memory scan.

Next, the CPI device determines whether the CPI is removed (406). If the CPI device determines the CPI is removed, the CPI device prepares the device for distribution (step 408). Preparing the device may include updating operating systems, applications, and other software for the device. Similarly, the device may be given a complete or partial systems check and re-packaged (with or without relevant accessories, manuals, and other necessary items) for distribution.

Next, the device is redistributed (410). Redistribution may include reselling, returning, shipping, or otherwise returning the device to the relevant party.

In response to determining the CPI is not removed in step 406, the CPI device records the device information and information documenting the CPI (step 412). The CPI device may record the date and time, the specific type of CPI found and secure documentation of the CPI, the location of the CPI on the electronic device, a party that initially performed or attempted CPI removal, and other information and metadata related to the device or attempted removal of the CPI.

Next, the CPI device cleans the CPI from the device (step 414). The CPI may be removed by overwriting appropriate selections, deleting or clearing specific or general portions of memory, utilizing built-in removal codes, scripts, or processes. The CPI may be removed automatically or based on actions of a user, operator, or technician (generically referred to as a user). In one embodiment, a module of the CPI device may remove the CPI from the electronic device utilizing a module and library defining locations of CPI for that specific electronic device.

Next, the CPI device reports the information regarding CPI removal (step 416). The information of step 412 may be utilized to generate a report and audit trail. The information may be stored in a database, web-portal, record, or other memory element. The records may be tracked for particular service providers, retailers, OEMs, or other parties as well as by particular devices, models, or fields of tracked information. As a result, it may be possible to determine whether there is frequently difficulty or troublesome to remove CPI from specific device types. As a result, the CPI device or removal process may be reconfigured to more effectively remove CPI for future devices. Step 412 may also involve sending one or more electronic messages including metadata to specified parties documenting the CPI. For example, service providers, CPI removal parties, managers, and others may be sent an email or report for every violation, daily, or weekly.

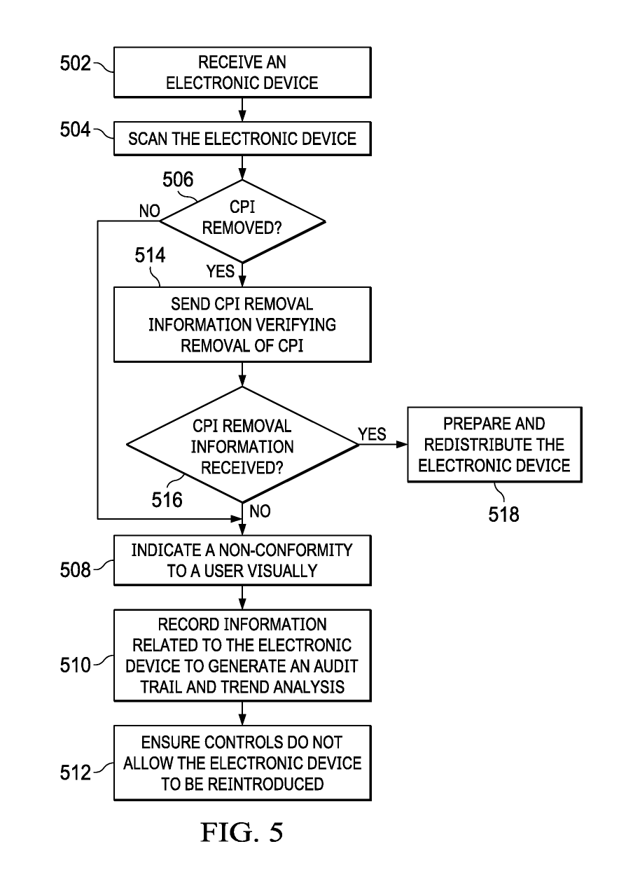

FIG. 5 is a flowchart of a process for verifying removal of customer private information from an electronic device in accordance with an illustrative embodiment. The process of FIG. 5 may be integrated with the process of FIGS. 1 and 4 or may be implemented as an independent process. The process of FIG. 5 may be implemented as a gatekeeping point during any part of a merchandising process for detecting CPI and reporting the CPI to specified parties.

The process may begin by receiving an electronic device (step 502). An adapter, interface or ports may be utilized to wirelessly or physically connect the CPI device to the device through a proprietary or standard connection.

Next, the CPI device scans the electronic device (step 504). The scan determines the state of the electronic device and CPI stored or accessible through the device. The CPI device determines whether the CPI is removed (step 506). For example, the current state of the electronic devices is compared to a desired state utilizing memory maps.

If the CPI is determined to still be present on the electronic device, the CPI device indicates a non-conformity to a user visually (step 508). In one embodiment, an alert may be presented to a user indicating the non-conformity/failure to the user. The alert may be utilized to implement additional manual or automatic processes for the electronic device, such as a complete memory wipe and reinstallation of an operating system and applicable applications.

Next, the CPI device records information related to the electronic device to generate and audit trail and trend analysis (step 510). The audit trail and trend analysis may be utilized to more effectively remove CPI from electronic devices in the future and to indicate potential issues. In some cases, the audit trail may be required to document business practices, compliance with rules and logic, to ensure compliance with laws and business policies.

Next, the CPI device ensures controls do not allow the electronic device to be reintroduced (step 512). The controls may include printing up a “CPI FAILURE” sticker or quarantine label for the electronic device or storing a message in the electronic device itself indicating that all CPI is not removed. For example, a user may be required to physically scan the device to remove CPI that is unable to be removed through the automated process.

If the CPI is determined to have been removed in step 506, the CPI device sends CPI removal information verifying removal of CPI (step 514). The CPI removal information may be sent to designated parties, saved in a database, or otherwise communicated to specified parties.

Next, the CPI device determines whether the CPI removal information is received (step 516). In one embodiment, an electronic confirmation or indication may be required to acknowledge that the CPI removal information is received by an application, system, device, equipment, or user. If the CPI removal information is not received, the CPI device indicates a non-conformity to a user visually (step 508). The non-receipt of the CPI removal information may require correcting and documentation before the electronic device may be subsequently redistributed.

If the CPI removal information has been received in step 516, the electronic device is prepared and redistributed (step 518). The electronic device may be updated with the most current software, repackaged, and then redistributed through the proper channels and with the appropriate documentation indicating that all CPI has been removed and if necessary re-verified with a memory map or other information stored.

FIG. 6 is a flowchart of a process for auditing electronic devices for CPI during processing in accordance with an illustrative embodiment. The process of FIG. 6 may be implemented by one or more of a warehouse management system 602, a CPI removal system 604, and a flashing system 606. In one embodiment, one or more of the warehouse management system 602, the CPI removal system 604, and the flashing system 606 (generically referred to as the “WMS” 602) may be integrated in a device, system, or networked implementation as herein described or in the incorporated reference. The WMS 602 may be utilized as an automatic tool to minimize the possibility of introducing an electronic device including CPI to a customer or the stream of commerce based on human error.

In one embodiment, the process of FIG. 6 may be implemented for a warehouse processing or logistics control system or facility. The process of FIG. 6 may be implemented by testing a device to determine whether CPI is present (step 608). The determination of step 608 may be performed numerous times by scanning or analyzing the applicable electronic device. Step 608 may additionally include deleting CPI if detected. In one embodiment, the determination of step 608 may make the determination based on a real-time scanning process as well as evaluating previously recorded information for the electronic device. For example, during step 608, the WMS may determine whether the electronic device has been certified as not containing CPI, whether the electronic device is marked as having failed a test based on information in a record, or whether there is no record. The electronic device is required to include a field, maker, flag, or indicator that specifies that electronic device has been scanned or examined and found not to include CPI. In one embodiment, the WMS may lock out or prevent the electronic device from being entered into anything other than a quarantine queue if CPI is present. As a result, the problem with the electronic device including CPI cannot be propagated further. Metadata of devices including CPI are recording during step 608 for storage. The metadata may specify information, such as when CPI was found, who found it, how it was found, who had previously processed the device, the type and location of the data found, and all electronic images of the device previously generated and the current electronic image. As a result, after further processing the electronic device may be further analyzed utilizing the electronic device and the recorded metadata. In one embodiment, the metadata is stored in a quarantine table linked with the record for the individual electronic device. The quarantine information of the metadata ensures that the electronic device with CPI cannot be utilized in the allocating and shipping process to fulfill an order or request.

If CPI is detected during step 608, the WMS 602 marks the electronic device as including CPI (step 610). The WMS 602 may set a field or electronic indicator to specify that the electronic device includes CPI. Additionally, the electronic device may be physically marked with a sticker, bagged, and/or physically separated into a quarantine area. The WMS 602 also quarantines the electronic device (step 612). The electronic device may be physically and electronically quarantined. As a result, any attempts to electronically process the device may lock the user out of the system (i.e. an interface may display a quarantine notification and prevent the electronic device from being processed) and require the user to take procedures to again quarantine the device, such as walk it to a quarantine area. Next, the WMS processes the electronic device to remove the CPI (step 614). During step 614, the CPI may be removed or the device may be flashed to ensure removal of the CPI.

As shown, the CPI detection process of step 608 may be performed at any time before or after receiving (step 616), allocating (step 618), or shipping (step 620) the electronic device. In one embodiment, a load of merchandise, such as processed phones may be unable to be electronically accepted with a phone including CPI is included in the batch. As a result, the entire batch may be returned as being compromised, the individual phone may be returned or quarantined, or the electronic device may be further quarantined or separated with a record kept of the detection of the CPI and rejection of the electronic device as being received for processing. In another embodiment, if CPI is detected on a device during an allocating stage, all of the electronic devices that are in the same batch or being processed with the electronic device may be locked down until each is individually tested. In another embodiment, electronic devices may be randomly tested at any time to ensure that the CPI removal process and procedures are being followed and implemented. The audit information may be automatically uploaded, updated, or sent to specified parties, such as a service provider.

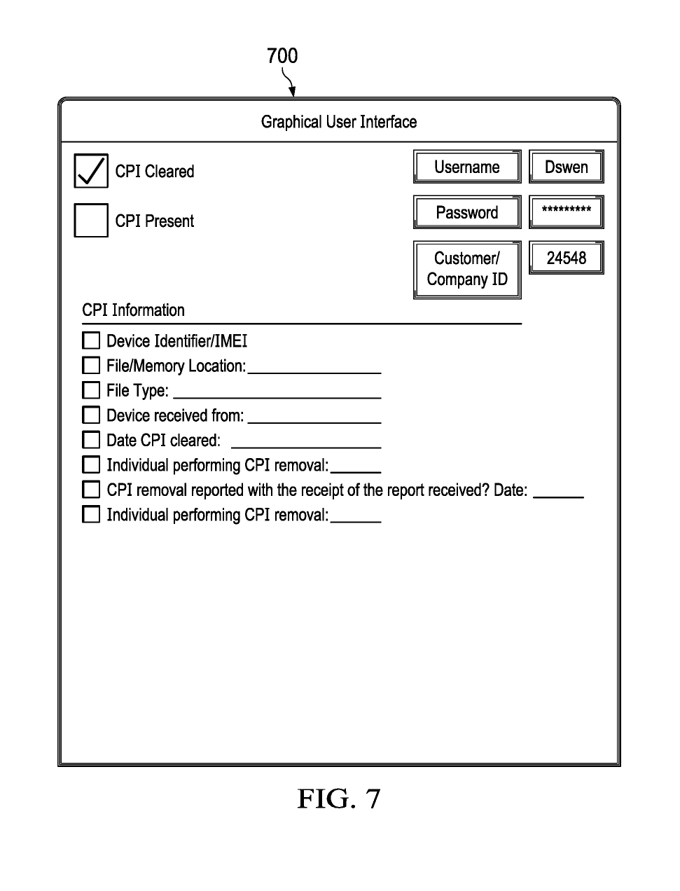

FIG. 7 is a pictorial representation of a graphical user interface for removing customer private information from an electronic device in accordance with an illustrative embodiment. The graphical user interface 700 is one embodiment of an interface that may be presented. The graphical user interface may include information that is automatically populated based on the CPI detection and removal process. Additionally, the graphical user interface 700 may allow interaction with a user. In one embodiment, the user may be required to present identification information, such as a username, password, company identification, or other access information to access the graphical user interface and/or control the CPI device.

In one embodiment, the graphical user interface 700 may indicate whether the CPI has been removed or is still present. The graphical user interface 700 may also indicate the electronic device identifier, file locations(s) of CPI, file types, a party the electronic device is received from, date the CPI was cleared, a user in charge or removing the CPI, CPI removal reports sent and received.

The graphical user interface 700 may include any number of views, windows, and access information for initiating, managing, and reviewing the CPI detection and removal from electronic devices. For example, the graphical user interface 700 may be utilized to generate reports or audits for specific electronic devices or for groups of electronic devices (such as lots or batches of electronic devices received).

The graphical user interface 700 may include any number of fields and menus for selecting the electronic devices for testing. The graphical user interface 700 may also present options, look-up features, and input fields for adding new device types (i.e., new makes and models) for updating the logic and libraries utilized to perform testing.

The systems, devices, and processes as herein described may be mixed, substituted, or combined in any number of embodiments. FIG. 8 is a flowchart of a process for processing a device for CPI in accordance with an illustrative embodiment. The process of FIGS. 8-10 may be implemented by a processing company (“processor” i.e., warehousing company, logistics control facility, etc.) utilizing a CPI device, warehouse management system, or other electronic and tracking tools. The process begins with product arriving at a dock (step 802). The product represents a shipment of one or more electronic devices. The product may be received via any number of shipment or delivery processes, such as truck, boat, train, and plane to name a few.

Next, the processor transfers the product from the truck to a staging area (step 804). The processor analyzes the product with a CPI tool (step 806). The processor creates a pass or fail record for each unit based on the presence of CPI and/or missing defaults (step 808). For example, a cell phone that does not include CPI may be marked as passing while another cell phone that does not include CPI, but is missing defaults may be marked as failing. Defaults may include software, such as operating systems and applications, updates or other hardware or software requirements for the unit. Units, such as PDAs, that include CPI are marked with a failing record.

Next, the processor attempts to complete receipt inventory (step 810). The processor also creates a quarantine record for each unit with the fail record or a missing record (step 812). For example, the quarantine record may be assigned by the CPI tool in an independent process or as part of step 808.

Next, the processor determines whether a quarantine is present (step 814). The quarantine may include a physical or electronic quarantine label or identifier associated with the respective unit. If there is not quarantine present, the processor receives the inventory with pass records (step 816). Next, the processor continues normal warehouse operations (step 818). For example, the units may be refurbished, repaired, shipped, and so forth.

If the processor determines the quarantine is present in step 814, the processor systematically blocks receipt of inventory with fail records or missing records (step 820).

Next, the processor determines whether to return the product to the vendor (step 822).

If the processor determines to return the product to the vendor, the process ends with the not being accepted or otherwise returned to the vendor or other party.

If the processor determines not to return the product to the vendor in step 822, the processor uses the CPI tool to clear the CPI (step 824). The processor may alternatively use a flashing tool or device to clear the CPI before returning to analyze the product with the CPI tool (step 806).

FIG. 9 is a flowchart of a process for allocating units in accordance with an illustrative embodiment. The process of FIG. 9 may begin by receiving an order (step 902). Next, the processer attempts to allocate inventory from a specific inventory bin for allocation (step 904).

Next, the processor determines whether there is quarantined product in the bin (step 906). The quarantined product may be detected by evaluating physical and electronic identifiers, randomly or systematically testing the product in the bin for CPI, or otherwise determining the product is quarantined or should have previously been quarantined.

If there is not quarantined product, the processor allocates units from the bin (step 908) before continuing normal warehouse operations (step 910).

If quarantined product is found in the bin in step 906, the processor locks the bin so that no inventory from this location may be used for an order (step 912). The processes, checkpoints, policies, procedures and systems of the processor may then be evaluated to determine how the product was moved into the bin.

FIG. 10 is a flowchart of a process for shipping a unit in accordance with an illustrative embodiment. The process of FIG. 10 may begin with the processor attempting to print a shipping label for a unit (step 1002).

The processor checks for a quarantine record for the unit (step 1004) as an integrated or separate part of the printing process. The processor then determines whether there is a quarantine record (step 1006). If there is not a quarantine record, the processor prints the shipping label (step 1008). The printing label may be printed from one or more printing devices in communication with the CPI device/WMS.

If the processor determines there is a quarantine record in step 1006, the processor will not print the shipping label (step 1010). In one embodiment, an error or alert message may indicate that the unit must be quarantined may be communicated or displayed to applicable personal. The unit may also be separated and marked as quarantined with additional process and system analysis to determine how the unit reached that location or point in processing.

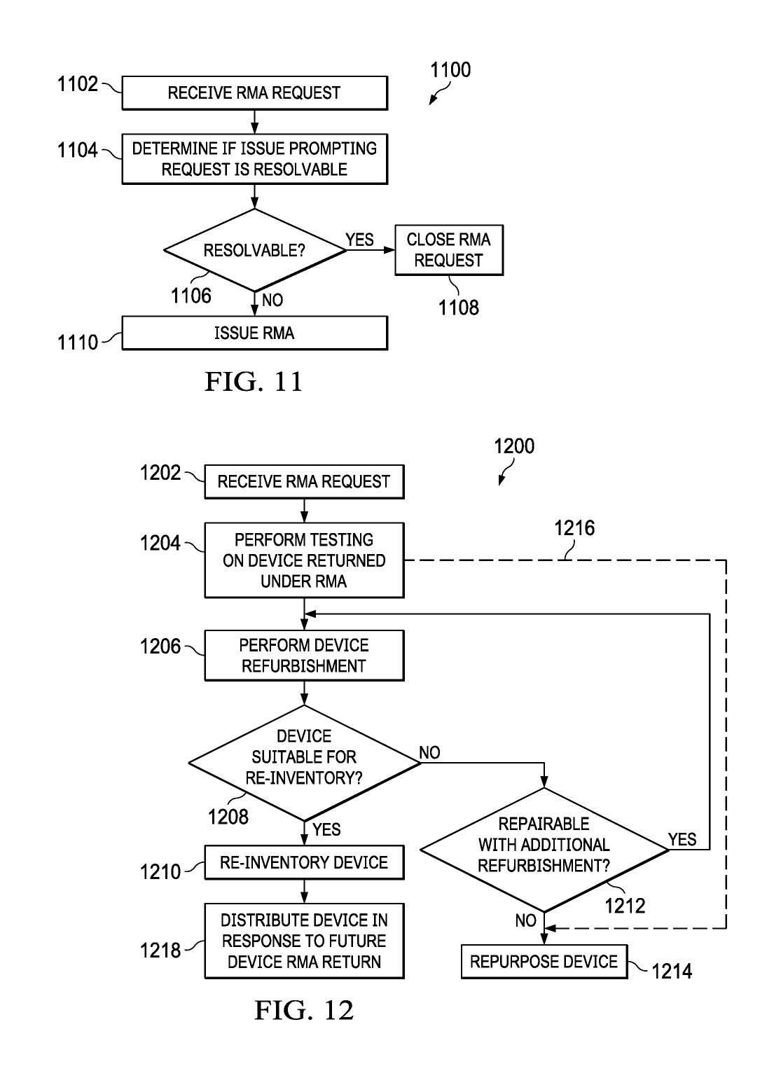

Turning to electronic device return strategies, FIG. 11 is a flowchart of a process 1100 for resolving a return merchandise authorization (RMA) request prior to issuance of an RMA. An RMA is a step typically performed when a purchaser attempts to return the electronic device for repair, replacement, or a refund during a warranty period of the electronic device. The process of securing the RMA allows the vendor an opportunity to resolve issues with the electronic device while the electronic device is with the customer prior to accruing any inconveniences associated with return logistics for both the customer and the vendor. Initially, at block 1102, the vendor receives a request from the customer for the RMA. The request may be received directly by the vendor, or through a third party contracted to handle troubleshooting of the electronic device prior to issuing the RMA. During block 1102, the party receiving the request for the RMA may verify that the product is under warranty or is otherwise eligible for a repair, replacement, or a refund.

Upon verification that the product is eligible for receiving the RMA, at block 1104 the party receiving the request makes a determination as to whether the issue prompting the RMA request is resolvable. During block 1104, the party receiving the RMA request may troubleshoot common issues that arise with the electronic device. For example, the party receiving the RMA request may walk the customer through a power cycle of the electronic device or through a software update that issued subsequent to a manufacture date of the electronic device. Other troubleshooting actions may also be completed during block 1104 by the party receiving the request.

When the party receiving the request has finished the troubleshooting actions assigned for the electronic device, at decision block 1106 a determination is made as to whether the issue prompting the RMA request is resolvable. If the issue is resolved during troubleshooting, the RMA request is closed at block 1108. Upon closure of the RMA request, the customer maintains possession and/or ownership of the electronic device as the party receiving the RMA request has resolved the issue that motivated the user to request the RMA. The issue prompting the RMA request and the process that resolved the issue may be recorded to provide greater efficiency when a similar issue is encountered in the future for another electronic device. The records, or log entries, may be stored in the memory of the warehouse management system 102.

If the issue prompting the RMA request is not resolvable, at block 1110 the RMA is issued to the customer. The RMA issued to the customer provides the customer with authorization to return the electronic device under the warranty agreement. A resulting RMA number accompanies the returned electronic device to a return facility. The RMA number identifies the object being returned, and a log entry detailing attempts to troubleshoot the issue prompting the RMA request may be associate with the RMA number within the WMS 102, for example. The RMA number also enables the return facility to ensure that the correct electronic device is returned under the RMA number. For example, a stock keeping unit (SKU) and/or a universal product code (UPC) associated with the returned electronic device may be associated with the RMA number. In this manner, the return facility, for example through the WMS 102, may verify that the electronic device returned with the RMA number is the correct electronic device by comparing a SKU of the returned electronic device to a SKU associated with the RMA number. Other identification options may also be associated with the RMA number and stored in the WMS 102. For example, during block 1104, as part of the troubleshooting process, a customer may be asked to provide the party receiving the RMA request with a picture of the electronic device at issue. This picture may be stored in the WMS 102 and compared with the device returned under the RMA number to verify that the correct device was returned under the RMA number.

FIG. 12 is a flowchart of a process 1200 for re-inventorying an electronic device that is returned under an RMA. Initially, at block 1202, the RMA request is received. The RMA request may be received by the WMS 102 or other system authorized to receive RMA requests and issue the RMAs in response to a determination that the RMA is available for the electronic device. The procedure for determining that the RMA is available for the electronic device is discussed in detail above with respect to FIG. 11.

At block 1204, the WMS 102 determines testing to be performed on an electronic device returned under the RMA. By way of example, the testing of the electronic device may be make and model specific. For example, a device made by a certain manufacturer may have a different testing procedure than a device made by another manufacturer. Similarly, testing may also vary based on differences between models made by the same manufacturer. Testing may include, but is not limited to, CPI testing, electronic device functionality testing, physical condition testing, software testing, hardware testing, cosmetic testing, or any other types of testing that may be beneficial for determining an operating state of the electronic device. Further, the testing establishes any repair or refurbishment actions that would enable re-inventory of the electronic device. For example, the testing establishes any repairs or refurbishment actions that would enable the electronic device to be provided to a different customer as a replacement for a different electronic device returned under warranty by the different customer at a future time.

Additionally, at block 1204, part of the testing may include determining that the electronic device returned under the RMA is the correct electronic device. For example, a stock keeping unit (SKU) associated with the returned electronic device may be associated with the RMA number. Because the electronic device may not be aware of the SKU assigned to the electronic device, the WMS 102 may use a combination of data about the electronic device to determine the correct SKU. For example, the WMS 102 may collect a make, a model, a memory size, a color, and a carrier of the electronic device to determine the SKU. The make, the model, and the carrier may all generally be known by the electronic device. Accordingly, this information may be downloaded directly from the electronic device. The memory size may be calculated using by interrogating the device using a memory calculation test. Additionally, the color of the device may be determined by decoding a product code of the electronic device, checking with an outside system (e.g., a camera), or any other color determining tests. The SKU of the electronic device may be determined from electronic information read from the electronic device (e.g., the make, the model, the carrier of the device, etc.) and/or attributes that are determined from testing the electronic device (e.g., the memory size, the color, etc.). The totality of information collected by the WMS 102 about the electronic device may direct the WMS 102 to a correct SKU for the electronic device returned under the RMA. In this manner, the return facility, for example through the WMS 102, may verify that the electronic device returned with the RMA number is the correct electronic device by comparing a determined SKU of the returned electronic device to a SKU associated with the RMA number.

At block 1206, the determined repairs or refurbishment actions are performed on the electronic device. The repairs and refurbishment actions may include, but are not limited to, repairing or replacing faulty hardware, removing detected CPI from the device, installing updated software, repairing cosmetic defects of the electronic device, flashing the electronic device, unlocking a theft locked device, or any other value added operations that are performed on the electronic device. Upon completion of the repairs or the refurbishment actions, a determination is made, at block 1208, as to whether the electronic device is suitable for re-inventory. That is, the WMS 102 may make a determination that the electronic device is eligible for a return to the marketplace as a refurbished electronic device or for use as a warranty replacement after another electronic device is returned.

If the device is suitable for re-inventory, the WMS 102 instructs the device to be moved to a re-inventory bin for appropriate redistribution processing at block 1210. The re-inventory bin may transition the electronic devices to staging areas for redistribution of the electronic device to consumers. For example, the re-inventory bin may be moved from a testing area of the return facility to an inventory area of the return facility or another facility that processes electronic devices for redistribution. The WMS 102 may track the physical location of the electronic devices as the electronic devices are re-inventoried to reduce a likelihood of lost inventory and to maintain an accurate record of inventory at specific physical locations.

If the device is not suitable for re-inventory, then a determination is made, at block 1212, as to whether the electronic device is repairable with additional refurbishment. For example, in an embodiment, the electronic device repairs or refurbishment actions provided at block 1206 may not have placed the electronic device in condition for re-inventory. In such a situation, the WMS 102 makes a determination as to whether any lingering defects of the electronic device are repairable in a cost effective manner. If the electronic device is repairable, additional repairs or refurbishment actions are performed on the electronic device at block 1206. However, if the determination is that the electronic device is not repairable in a cost effective manner, the electronic device is repurposed at block 1214.

In an additional or alternative embodiment, a determination as to whether the electronic device is repairable in a cost effective manner may also be made at block 1204 when testing is performed on the electronic device. If the electronic device is repairable, the repairs and refurbishment actions are performed on the electronic device at block 1206. If the electronic device is not repairable in a cost effective manner, the electronic device is repurposed at block 1214, as indicated by path 1216.

In either embodiment, repurposing of the electronic device at block 1214 may involve scrapping the electronic device for parts that may be used for future repairs or refurbishment actions of another electronic device. For example, the WMS 102 may tag the electronic device physically and/or electronically for scrapping. When the electronic device is tagged for scrapping, the electronic device is sorted into an appropriate bin for movement to a scrapping facility. The electronic device may also be tagged physically and/or electronically for recycling by the WMS 102 at block 1214. When tagged for recycling, the electronic device is sorted into a recycling bin along with other electronic devices similarly tagged for recycling. The recycling bin is subsequently transported to a recycling facility. Additionally, tagging the electronic device physically and/or electronically may involve providing an indication of a make and model of the electronic device, the processing path of the electronic device after reaching the return facility, defective components of the electronic device, or any other information that may be useful for repurposing the electronic device. Further, the WMS 102 may maintain information about the electronic device returned under the RMA. For example, the WMS 102 may track the location of the electronic device, when the electronic device was checked into or out of a specific area of the return facility, the defective components of the electronic device, or any other information that may be useful for repurposing the electronic device.

In another embodiment, after the electronic device is re-inventoried, the re-inventoried electronic device may be redistributed, at block 1218, to another purchaser who returns a different electronic device under an RMA. For example, the return facility may receive another RMA return of the same or similar make and model of the re-inventoried electronic device. As part of the terms of the RMA, the purchaser of the newly returned electronic device may be eligible for replacement of the newly returned electronic device with a reconditioned electronic device. Accordingly, the WMS 102 provides instructions to automatically ship the re-inventoried electronic device to the purchaser of the newly returned electronic device when the WMS 102 receives an indication that the newly returned electronic device has reached the return facility. Upon shipping of the re-inventoried device, the WMS 102 may update inventory records of available electronic devices to reflect that the re-inventoried electronic device was shipped to a consumer as a replacement electronic device in response to a separate RMA return.

FIG. 13 is a tree diagram illustrating a process 1300 for processing product return requests according to a disclosed embodiment. Although operations in the process 1300 are shown in a particular sequence, certain operations may be performed in different sequences or at the same time where feasible. Product return requests may be grouped into different categories or types of product returns, such as return requests upon receiving return merchant authorizations (RMAs), requests to process warranty claims, requests to repair electronic devices, requests to replace electronic devices, requests to trade-in electronic devices, requests to dispose electronic devices, as well as other categories of product return requests disclosed herein to service various electronic devices. In some embodiments, the product return requests are governed by various business rules that collectively specify whether to accept certain product return requests. The business rules for processing the product return requests are categorized into different categories such as a device condition category, a market condition category, a return plan category, and a vendor conditions category. As a result of the process 1300, the WMS 102, which may operate the process 1300, efficiently re-inventories returned electronic devices.

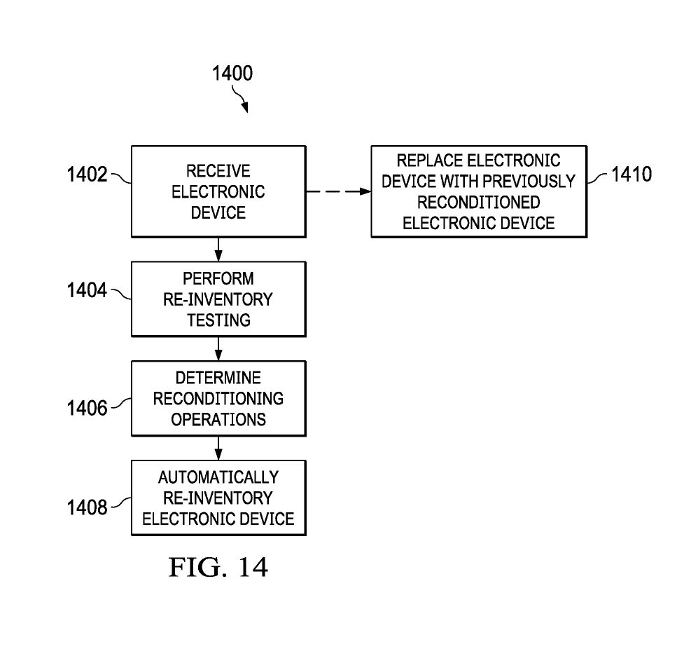

At block 1301, the processor 103 of the management logic 302 of the warehouse management system 102, for example, receives a product return request to return an electronic device for a full refund (a first product return request). At block 1305, the processor 103 of the management logic 302 accesses the libraries 308 to obtain information about the electronic device to be returned. While the management logic 302 and the libraries 308 are described with respect to FIG. 3 as being components of the CPI device 301, the management logic 302 and the libraries 308 may also be components of the warehouse management system 102, generally. In this manner, the warehouse management system 102 is able to determine information about the electronic device to be returned to plan a procedure for re-inventorying the electronic device, as discussed in greater detail below with respect to FIG. 14. As stated herein, information about the electronic device stored in the libraries 308 includes manufacturing specifications of the electronic device, market conditions of the electronic device, vendor information about the vendor of the electronic device, customer information about the customer of the electronic device, as well as other quantifiable information about the electronic device. For example, the processor 103 of the management logic 302 accesses the libraries 308 to determine the current inventory of the electronic device and to obtain various costs associated with the electronic device.

At block 1310, the processor 103 accesses the device condition category to obtain applicable business rules for processing the first product return request based on one or more device specific conditions. The device condition category is further divided into a physical condition subcategory and a device specification subcategory to provide more granular categorization of business rules for processing the first product return request. At block 1312, the processor 103 accesses the physical condition subcategory, which includes business rules for processing the first product return request based on the physical condition of the electronic device. The physical condition subcategory is further divided into a presence of damage subcategory, a damage type subcategory, a damage location subcategory, a missing component subcategory, and an unauthorized component subcategory.

At block 1312a, the processor 103 accesses the presence of damage subcategory to obtain business rules for processing the first product return request based on whether the electronic device is damaged. In some embodiments, the foregoing business rules specify whether the first product return request may be accepted based on whether the electronic device is damaged. In one of such embodiments, the foregoing business rules also specify whether the electronic device may be processed under a different category of product return request. For example, the business rules specify that the first product return request, which is to return the electronic device for a full refund, cannot be accepted due to damage to the electronic device. However, the electronic device may be returned for a partial refund, exchanged for another electronic device of identical model (an identical model device), or repaired and subsequently returned to the customer. The foregoing business rules may vary based on the device type of the electronic device. For example, the foregoing business rules may specify that the first product return request may be accepted if the electronic device is a smartphone, but the electronic device may only be exchanged if it is a television.

At blocks 1312b and 1312c, the processor 103 accesses the damage type subcategory and the damage location subcategory, respectively, to obtain business rules for processing the first product return request based on damage type and damage location, respectively. For example, the foregoing business rules may specify that the first product return request may be accepted if the damage is a scratch and the electronic device is a smartphone. However, the electronic device may only be repaired and returned to the customer if the damage is a shattered display screen. Moreover, the business rules may specify that the first product return request may be accepted if the scratch is on the casing of the electronic device but only a partial refund may be provided if the scratch is on the display screen of the electronic device. The foregoing business rules may also specify whether to accept the first product return request based on the severity of damages to the electronic device. In one embodiment, the severity of damages is based on the type of the damage and the location of the damage. In that regard, the processor 103 may perform one or more operations described herein to determine the severity of the damages. In some embodiments, the processor 103 is operable to provide all available types and categories of product return requests that satisfy the foregoing business rules. Continuing with the previous example, if the electronic device does not contain any damage, then the processor 103 may generate a notification that the first product return request has been accepted and provide a list of other acceptable categories of product return requests, such as to exchange the electronic device for a new identical device, to return the electronic device for vendor credit, to trade-in the electronic device for a different electronic device, as well as other quantifiable types and/or categories of product return requests.

At blocks 1312d and 1312e, the processor 103 accesses the missing component subcategory and the unauthorized component subcategory, respectively, to obtain business rules for processing the first product return request based on whether one or more components of the electronic device is missing and whether one or more unauthorized component are installed on the electronic device, respectively. In some embodiments, the processor 103 is operable to obtain the manufacturing specification of the electronic device to determine the authorized components of the electronic device. In one of such embodiments, the processor 103 is operable to communicate with the electronic device to determine which components are installed on the electronic device. In another one of such embodiments, the processor 103 is operable to operate one or more sensors to determine which components are installed on the electronic device. In such embodiments, the processor 103 is further operable to compare the authorized components with the actual components to determine if any authorized component is missing and/or if any unauthorized component is installed on the electronic device.

In some embodiments, the business rules include rules that specify whether to accept the first product return request as well as acceptable types and/or categories of product return requests based on whether there is any discrepancy, the type of the authorized component is missing, the type of the unauthorized component, the number of missing authorized components, and similar factors disclosed herein. For example, the business rules may specify that the first product return request cannot be accepted if the electronic device is a smartphone and is missing an authorized processor 103, but may be repaired if the electronic device is a smartphone and includes an unauthorized casing. Further, the business rules may specify that the electronic device may not be returned under any circumstance if certain authorized firmware programs have been altered to exploit certain features of the electronic device.

At block 1314, the processor 103 accesses the device specification subcategory, which is divided into a device age subcategory, a hardware specification subcategory, and an application specification subcategory. At blocks 1314a, 1314b, and 1314c, the processor 103 accesses the device age subcategory, the hardware specification subcategory, and the application specification subcategory, respectively, to obtain business rules for processing the first product return request based on the age of the electronic device, the specification of the hardware components of the electronic device, and the specification of applications of the electronic device, respectively. For example, the foregoing business rules may specify that the first product return request may not be accepted if the age of the electronic device is greater than a first threshold value, if the electronic device contains hardware components that are no longer manufactured by the vendor of the electronic device, or if the vendor of the electronic device no longer supports any of the applications installed on the electronic device. The foregoing business rules, similar to the business rules under the physical condition subcategory, may vary based on the device type of the electronic device. For example, the foregoing business rules may specify that the first product return request may be accepted if the electronic device is a watch and the device age of the watch is less than six months, but may only accept the first product return request if the electronic device is a tablet computer and the device age of the tablet computer is less than three months.

At block 1320, the processor 103 accesses the market condition category to obtain applicable business rules for processing the first product return request based on one or more market conditions. The market condition category is further divided into a service cost subcategory, a device availability subcategory, and an on-site inventory subcategory. At block 1322, the processor 103 accesses the service cost subcategory. The service cost subcategory is further divided into a replacement cost subcategory, a repair cost subcategory, and a labor cost subcategory. At blocks 1322a, 1322b, and 1322c the processor 103 accesses the foregoing subcategories, respectively, to obtain business rules for processing the first product return request based on the current replacement cost, the current repair cost, and the current labor cost, respectively. For example, the foregoing business rules may specify that the first product return request may be accepted if the replacement cost is below a first cost threshold. In addition, the electronic device may also be replaced for a new identical model device if the replacement cost is below the first cost threshold. However, the business rules may specify that the electronic device may be repaired but not replaced if the replacement cost is above the first threshold but the repair cost is below a second threshold. Further, the business rules may specify that only the first product return request is available if the labor cost is above a third threshold. In some embodiments, the foregoing costs as well as other costs discussed herein dynamically change based on the current market conditions. For example, if the labor cost associated with servicing the electronic device doubles within one month, then the same business rules that specify only the first product return request may be accepted one month may also accept additional available types and/or categories for product return requests in another month.

At blocks 1324 and 1326, the processor 103 accesses the device availability and the on-site inventory subcategories, respectively, to obtain business rules for processing the first product return request based on the number identical model devices available and the number of identical model devices that are on-site, respectively. For example, the foregoing business rules may specify that only the first product return request or a request to repair the electronic device may be accepted if the number of identical model devices is below a first threshold number of units or if the number of on-site identical model devices is below a second threshold number of units. However, the same business rules may specify that the electronic device may also be exchanged for an identical model device if the number of on-site identical model devices is greater than a third threshold number of units, where the third threshold is greater than the second threshold.

At block 1330, the processor 103 accesses the return plan category to obtain applicable business rules for processing the first product return request based on one or more return plans that cover the electronic device. The return plan category is further divided into a vendor return plan type subcategory, an in-warranty subcategory, an out of warranty subcategory, a third party coverage subcategory, and a customer credential subcategory. At block 1331, the processor 103 accesses the vendor service plan type category to obtain business rules for processing the first product return request based on the type of vendor service plan the electronic device is covered under. Examples of service plans offered by the vendor of the electronic device include various plans to return, replace, or exchange the electronic device as well as other types of return plans offered by electronic device vendors. The foregoing business rules specify whether to accept the first product return request and the availability of other types and/or categories of product return requests based on vendor service plans that cover the electronic device.

At block 1332, the processor 103 accesses the in-warranty subcategory if the electronic device is covered under one or more available warranties. The in-warranty subcategory is further divided into a warranty scope subcategory and a void warranty subcategory. At block 1322a, the processor 103 accesses the in-warranty subcategory to obtain business rules for processing the first product return request based on the scope of warranties that cover the electronic device. For example, the foregoing business rules may specify that the first product return request may not be accepted and that only a partial refund may be processed based on the scope of the warranties that cover the electronic device. At block 1332b, the processor 103 accesses the void warranty subcategory to obtain business rules for processing the first product return request if certain conditions would void one or more warranties that cover the electronic device, and if at least one of such conditions has been satisfied. For example, the foregoing business rules may specify certain software exploitations, such as jailbreaking the electronic device or presence of certain types of damages, such as water damage to interior components of the electronic device, would void all available warranties that cover the electronic device. In such case, the processor 103 rejects the first product return request and indicates that no other type and/or category of product return request is available upon determining that a condition that would void all of the warranties has been satisfied.

At block 1334, the processor 103 accesses the out of warranty subcategory if the electronic device is not covered under any warranty. In some embodiments, the business rule specifies that the electronic device may not be returned under any type and/or category of product return request. In other embodiments, the business rules specify that although the first product return request may not be accepted, the electronic device may be exchanged for vendor credit.

At block 1336, the processor 103 accesses the third party coverage subcategory if the electronic device is covered under one or more third party return plans. As defined herein, third party return plans include any return plan that is not provided by the vendor of the electronic device. Third party return plans include return plans from credit card companies, insurance companies, as well as other companies that provide return plans in addition to return plans provided by the vendor. For example, if the electronic device is insured by an insurance agency under an insurance plan, then the first product return request may still be accepted based on the terms of the insurance plan regardless of whether the electronic device is in-warranty or out of warranty.

At block 1338, the processor 103 accesses the customer credential subcategory to obtain business rules that specify whether the first product return request may be accepted based on whether the processor 103 has access to sufficient customer credentials. Customer credentials may include customer information, such as the customer's address, telephone number, credit card information, biological information, customer passwords, as well as other quantifiable information that is related to the customer, or information that indicates that the consumer is authorized to submit the first product return request. The processor 103 may obtain the customer credentials from the libraries 308. The processor 103 may also query the customer to provide additional customer credentials if the processor 103 does not have access to sufficient customer credentials. In some embodiments, customer credentials may also be established by satisfying a set of guidelines for returning the electronic device. For example, the guidelines for accepting the first product return request may require the customer to first submit an online return merchandise authorization (RMA) request within a first threshold period of time. In one of such embodiments, the first product return request may not be accepted until the customer has submitted the RMA request and has received a confirmation from the vendor of the electronic device.

At block 1340, the processor 103 accesses the vendor conditions category to obtain applicable business rules for processing the first product return request based on one or more vendor specified conditions. The vendor conditions category is further divided into a customer based conditions subcategory and a location based conditions subcategory. At block 1342, the processor 103 accesses the customer based conditions subcategory to obtain business rules for processing the first product return request based on one or more vendor instructions regarding returns made by the customer of the electronic device. In some embodiments, the vendor of the electronic device has one or more pre-arrangements with the customer of the electronic device. For example, if the customer of the electronic device is a top purchaser of the vendor's products, then the vendor may accept all product returns from the customer regardless of whether the returned products are covered under one or more warranties. At block 1344, the processor 103 accesses the location based conditions subcategory to obtain business rules for processing the first product return request based on the location of the return facility, the location of the customer, the location of the vendor, as well as other location based considerations. For example, the return facility may be located in a jurisdiction that contains specific laws and regulations that govern how to process the first product return request as well as other available types and/or categories of product return requests. The laws and regulations may control how to package and handle the electronic device, how to recycle certain components of the electronic device, whether to collect fees and/or taxes, the amount of fees and taxes to be collected, as well as other aspects of returning the electronic device.

In some embodiments, the processor 103 transmits an electronic message to the customer indicating whether the first product return request has been accepted. In one of such embodiments, the electronic message includes reasons why the first product return request is not accepted under the first product return request in response to a determination that the first product return request should not be accepted. In another embodiment, the electronic message includes an option for retrieving at least one of detailed images and video of the electronic device depicting a device condition of the electronic device upon opening of a package in which the electronic device is received. In some embodiments, certain business rules for processing the first product return supersede other business rules for processing the first product return. In one of such embodiments, business rules associated with vendor based conditions supersede business rules associated with return plans that cover the electronic device. In some embodiments, the processor 103 may simultaneously proceed through multiple blocks of the process 1300. For example, the processor 103 may simultaneously proceed through blocks 1312a-1312e to obtain business rules that specify whether to accept the first product return request based on presence of damage, damage type, damage location, whether one or more authorized component are missing and whether one or more unauthorized components are installed on the electronic device. As such, the process 1300 allows the processor 103 to efficiently determine applicable business rules for processing the first product return. Further, the process 1300 enables the warehouse management system 102 to collect electronic device information from the electronic device to determine a process to re-inventory the returned electronic device, as discussed in detail below with respect to FIG. 14.

Although the previous paragraphs describe the process 1300 being performed by a processor 103 of the system 200, the process 1300 may also be performed by other systems described herein, or by similar systems that are operable to obtain business rules for processing product returns and process product returns based on the obtained business rules. Further, although the operations describe obtaining business rules to process the first product return request of the electronic device, the operations may also be performed to obtain other business rules to process other types and/or categories of product return requests of other electronic devices.

FIG. 14 is a flowchart of a process 1400 for automatically re-inventorying an electronic device. Initially, at block 1402, the electronic device is received at a returns facility. Upon receipt of the electronic device, electronic device information may be collected by the WMS 102. The electronic device information may include an RMA number, the make and model of the electronic device, the age of the electronic device, hardware present in the electronic device, software installed on the electronic device, warranty status, or any other information that may be beneficial to re-inventory testing and re-inventorying of the electronic device. By way of example, performing the process 1300, as described above with respect to FIG. 13, may provide the WMS 102 with the electronic device information when the return facility receives the electronic device.

At block 1404, re-inventory testing is performed on the electronic device. As discussed above with respect to FIG. 12, tests performed at block 1404 may be determined based on the information collected at block 1402 when the electronic device is received at the return facility. The testing of the electronic device may be make and model specific. For example, a device made by a certain manufacturer may have a different testing procedure than a device made by another manufacturer. Similarly, testing may also vary based on differences between models made by the same manufacturer. Testing may include, but is not limited to, CPI testing (e.g., testing for presence of CPI on the electronic device), physical condition testing (e.g., testing for the condition of the components of the electronic device), software testing (e.g., testing that the software on the electronic device is functioning properly), hardware testing (e.g., testing that hardware components of the electronic device are functioning properly), cosmetic testing (e.g., testing for cosmetic defects of the electronic device that do not affect the structure or functionality of the electronic device), or any other types of testing that may be beneficial for determining an operating state of the electronic device. Further, the testing establishes any repair or refurbishment actions that would enable re-inventory and subsequent redistribution of the electronic device. For example, any repairs or refurbishment actions that would enable the electronic device to be provided to a customer as a warranty replacement for an electronic device returned under warranty at a future time. A determination as to which tests are conducted on the electronic device may be made by the WMS 102 based on the electronic device information collected at block 1402.

At block 1406, reconditioning operations, which include repair operations, refurbishment operations, or both, are determined based on the results of the re-inventory testing. The repair or refurbishment operations are selected by the WMS 102 to return the returned electronic device to a condition suitable for redistribution. The repairs and refurbishment actions may include, but are not limited to, repairing or replacing faulty hardware, removing detected CPI from the device, installing updated software, repairing cosmetic defects of the electronic device, or any other value added operations that are performed on the electronic device.

Upon completion of the determined repairs or refurbishment operations, at block 1408 the WMS 102 automatically re-inventories the returned electronic device. Automatically re-inventorying the returned electronic device may include physically or electronically tagging the returned electronic device with an indication relating to sorting of the electronic devices during re-inventory. For example, if the electronic device is in a condition sufficient for redistribution to the marketplace or as a warranty replacement, the electronic device may be tagged by the WMS 102 with an inventory status to direct the electronic device to a bin for redistributing electronic devices. Alternatively, if the electronic device remains in a condition not sufficient for redistribution, or if the electronic device was received in an unrepairable condition, the electronic device may be tagged by the WMS 102 with an inventory status to direct the electronic device to a recycle or scrapping bin. In addition to physically or electronically tagging the returned electronic device, records of an inventory system in the WMS 102 may be automatically updated with the inventory status of the electronic device to indicate the addition of the electronic device to inventory, or to another warehouse location or facility to which the electronic device is assigned (e.g., a scrap or recycling bin).

The WMS 102 may also track other aspects of the re-inventorying process 1200 acting on the electronic device. For example, the WMS 102 maintains a physical location of the electronic device (e.g., testing facility, inventory bin, scrap bin, redistribution facility, scrap facility, etc.). Further, the WMS 102 may maintain results of the tests conducted on the electronic device and any reconditioning actions performed on the electronic device resulting from the results of the tests conducted on the electronic device. Additionally, the original manufacturing date of each electronic device undergoing the re-inventorying process 1200 may be stored at the WMS 102. The WMS 102 may use the original manufacturing date to order the re-inventoried devices for redistribution. For example, the oldest devices within an acceptable age range may be redistributed to consumers before the newer devices to avoid unnecessarily holding the re-inventoried electronic devices beyond a usable manufacturing date, as discussed in detail below with respect to block 1410.

In an embodiment, when the electronic device is returned under a return merchandise authorization (RMA), at block 1410 the WMS 102 automatically triggers replacement of the electronic device with a previously reconditioned and re-inventoried electronic device. For example, the previously reconditioned electronic device may have already completed the process 1400, and the previously reconditioned electronic device is maintained in inventory until the return facility receives an electronic device newly returned under an RMA. At that point, the WMS 102 automatically provides an indication that the previously reconditioned electronic device is to be sent to the customer that returned the electronic device under terms of the RMA. Further, when an electronic device is returned without an RMA but still under warranty, and the warranty allows a return of the electronic device without the RMA, the WMS 102 may also automatically trigger replacement of the electronic device with the previously reconditioned electronic device at block 1410.

For a returned device to qualify for re-inventory and redistribution as a reconditioned electronic device, certain criteria are met by the electronic device. For example, one criterion may involve an original manufacture date of the reconditioned electronic device. For redistribution, the reconditioned electronic device, in an embodiment, may only be redistributed at block 1410 when the original manufacture date of the electronic device is less than a year prior to the redistribution of the electronic device. Other amounts of time prior to the redistribution date are also contemplated as falling within the spirit of the present disclosure. Such a criterion avoids the redistribution of electronic devices that may suffer from defects that relate to the age of components of the reconditioned electronic device. Additionally, criteria to qualify the re-inventoried electronic device for redistribution may include verification of removal of CPI from the electronic device and verification that the electronic device has passed all tests performed on the device during the re-inventorying process 1200, for example. Other tests may also be performed on the reconditioned electronic device to ensure appropriate functionality of the electronic device prior to redistribution.

The WMS 102, in addition to providing instructions to perform the re-inventorying process 1200, stores electronic device information relating to the re-inventorying process 1200 and also tracks the electronic device as the electronic device undergoes the re-inventorying process 1200. For example, the WMS 102 may update the electronic device information every time a test is completed, every time the electronic device transitions from one physical location to another (e.g., from a testing area of a return facility to an inventory area of the return facility), and any time a status of the electronic device changes (e.g., the electronic device transitions from “testing” to “re-inventoried”). Other updates of the electronic device are also contemplated.

While this specification provides specific details related to certain testable components of the electronic devices, it may be appreciated that the list of testable components is illustrative only and is not intended to be exhaustive or limited to the forms disclosed. Other testable components of the electronic devices will be apparent to those of ordinary skill in the art without departing from the scope and spirit of the disclosure. Further, the scope of the claims is intended to broadly cover the disclosed testable components and any such testable components that are apparent to those of ordinary skill in the art.

As used in this specification and any claims of this application, the terms “computer”, “server”, “processor”, and “memory” all refer to electronic or other technological devices. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The above disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flow diagrams depict serial processes, some of the steps/blocks may be performed in parallel or out of sequence, or combined into a single step/block. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A method to automatically re-inventory an electronic device, the method comprising:
collecting electronic device information upon receipt of the electronic device at an electronic device returns facility;
performing re-inventory testing of the electronic device;
performing reconditioning operations on the electronic device in response to results of the re-inventory testing;
automatically re-inventorying the electronic device upon completion of the reconditioning operations.

2. The method of claim 1, wherein collecting the electronic device information comprises determining whether the electronic device is returned under a return merchandise authorization (RMA).

3. The method of claim 2, wherein determining whether the electronic device is returned under the RMA comprises verifying that the electronic device received at the electronic returns facility is associated with the RMA.

4. The method of claim 2, wherein determining whether the electronic device is returned under the RMA comprises verifying that the electronic device received at the electronic returns facility matches an expected electronic device of the RMA.

5. The method of claim 4, wherein verifying that the electronic device received at the electronic returns facility matches the expected electronic device comprises comparing a stock keeping unit of the electronic device to a stock keeping unit associated with the RMA.

6. The method of claim 1, comprising determining re-inventory tests to be performed on the electronic device based on the electronic device information.

7. The method of claim 1, wherein automatically re-inventorying the electronic device comprises:
tagging the electronic device with an indication of where the electronic device is to be transported; and
updating an inventory system with an inventory status of the electronic device.

8. The method of claim 1, wherein the re-inventory testing of the electronic device comprises customer private information (CPI) testing.

9. The method of claim 1, wherein the reconditioning operations comprise customer private information (CPI) removal and CPI removal verification.

10. The method of claim 1, wherein automatically re-inventorying the electronic device comprises repurposing the electronic device when the electronic device is not suitable for redistribution upon completion of the reconditioning operations.

11. A computer implemented method for automatically re-inventorying an electronic device, the method comprising:
collecting electronic device information upon receipt of the electronic device at an electronic device returns facility;
performing CPI testing of the electronic device;
removing CPI from the electronic device in response to detecting the CPI on the electronic device during the CPI testing;
verifying removal of the CPI from the electronic device;
automatically re-inventorying the electronic device upon verification that the CPI has been removed from the electronic device.

12. The computer implemented method of claim 11, wherein collecting the electronic device information comprises determining whether the electronic device is returned under a return merchandise authorization (RMA).

13. The computer implemented method of claim 12, wherein determining whether the electronic device is returned under the RMA comprises verifying that the electronic device received at the electronic returns facility is associated with the RMA.

14. The computer implemented method of claim 11, wherein verifying that the electronic device received at the electronic returns facility is associated with the RMA comprises comparing a stock keeping unit of the electronic device to a stock keeping unit associated with the RMA.

15. The computer implemented method of claim 11, wherein automatically re-inventorying the electronic device comprises:
tagging the electronic device with an inventory status of the electronic device; and
updating an inventory system with the inventory status of the electronic device.

16. A warehouse management system comprising:
a processor for executing a set of instructions; and
a memory for storing the set of instructions, wherein the set of instructions are executed to:
collect electronic device information upon receipt of an electronic device at an electronic device returns facility;
determine re-inventory tests of the electronic device based on the electronic device information;
perform re-inventory testing of the electronic device using the determined re-inventory tests;
determine at least one reconditioning operation to be performed on the electronic device in response to results of the re-inventory testing;
automatically re-inventory the electronic device upon completion of the reconditioning operations.

17. The warehouse management system of claim 16, wherein instructions executed to collect the electronic device information comprise instructions executed to determine whether the electronic device is returned under a return merchandise authorization (RMA).

18. The warehouse management system of claim 17, wherein instructions executed to determine whether the electronic device is returned under the RMA comprise instructions executed to verify that the electronic device received at the electronic returns facility matches an expected electronic device associated with the RMA.

19. The warehouse management system of claim 16, wherein instructions executed to automatically re-inventory the electronic device comprise instructions executed to:
tag the electronic device with an inventory status that the electronic device is available for redistribution as a warranty replacement; and
update an inventory system with the inventory status of the electronic device.

20. The warehouse management system of claim 16, wherein instructions executed to perform re-inventory testing comprise instructions executed to:
test the electronic device for customer private information (CPI); and
verifiably remove the CPI from the electronic device upon detecting the CPI on the electronic device.
